(19) United States
(12) Patent Application Publication
(10) Pub. No.: US 2010/0226568 A1
(43) Pub. Date: Sep. 9, 2010

(54) EFFECTIVE COLOR MODELING METHOD FOR PREDICTIVE IMAGE COMPRESSION

(75) Inventors: Vladimir SEMENYUK, Stockholm (SE); Serge VOLKOFF, San Bruno, CA (US)

Correspondence Address: STAINBROOK & STAINBROOK, LLP, 412 AVIATION BOULEVARD, SUITE H, SANTA ROSA, CA, 95403, US

(73) Assignee: SMITH MICRO SOFTWARE, INC., Aliso Viejo, CA (US)

(21) Appl. No.: 12/400,663

(22) Filed: Mar. 9, 2009

(51) Int. Cl. G06K 9/00

(52) U.S. Cl. 382/166

(57) ABSTRACT

A method for effective color modeling for predictive image encoding. Colors are processed on a binary basis, when each color index is treated as a binary value. Binary digits are processed sequentially with the use of context-based approach. The context is calculated as a unique combination of binary values of already processed digits, the position of the digit currently being processed and an additional identifier from a limited set of identifiers that describe differences between the predicted color index and the averaged color index being reconstructed during bitwise processing. Color mapping, table operations and a special rules for efficient difference identification are proposed as major enhancements of the method.

### CROSS REFERENCES TO RELATED APPLICATIONS

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to compression techniques for digital image files of various formats. More specifically, the present invention relates to predictive context-based lossless image compression.

2. Discussion of Related Art Including Information Disclosed Under 37 CFR §§1.97, 1.98:

Lossless compression is a process of economical representation of source information. Lossless compression methods are used in many technical areas, including multimedia, data processing and communication applications. One of the most important branches of lossless compression technologies is lossless compression of digital images in which photographs and other images are stored. Generation of efficient economical image presentation is most often based on predictive context-based encoding (such as lossless JPEG). At each image position, colors are predicted by estimating a color probability distribution using a context. With a probability distribution it is possible to generate a highly efficient, decodable code using various entropy encoding methods in which code lengths are determined by the probability distribution. More precisely, code length is bounded below by distribution entropy (empirical entropy in practical applications) and this limit can be reached in practice with the use of most advanced implementations of entropy encoding. Therefore, it is necessary to minimize the empirical entropy by choosing an appropriate context or contexts (when distribution is obtained as a superposition of several context based distributions.)

A context is usually a digest of color information derived from already processed, adjacent image positions. Because the number of different combinations of colors at adjacent positions can be extremely large, in practice this digest is often simply a prediction of color, some index in indexed (numbered) color space that identifies the color being predicted. It is assumed that this prediction is precise enough and prediction error on average is very close to zero. Prediction can be calculated as a weighted superposition of color indexes at adjacent positions or in a different way, including non-linear approaches.

Even a simple prediction of colors requires significant memory resources for statistics collection. It takes N² counters to store N probability distributions with N elements in each distribution corresponding to a single predictor, where N is the number of all possible colors and therefore, possible predictions. Although in practice the number of used (nonzero) counters is smaller than the maximum, this number is still large and typically behaves as O(N²). Yet another problem of color prediction is that statistics are accumulated slowly because there are many possible combinations of actual and predicted color indexes. At least at the beginning of encoding, statistical color distributions may diverge from the overall distributions in the image source.

A common solution for problems described above is statistical modeling of prediction errors rather than actual color indexes. The number of possible prediction errors is significantly smaller than the number of possible combinations of predicted and actual colors. Further, prediction errors can be modeled in groups or efficiently described parametrically with the use of a small number of parameters. The main disadvantage of this approach is that the specific character of the general color distribution is not taken into consideration. Compression efficiency thus suffers as a result, especially in the case of preprocessed or artificial images with discontinuous color distributions.

The foregoing patents reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present method combines advantages of both actual color prediction and error modeling approaches. Color index is treated as a binary value. During encoding/decoding binary digits of color index are processed sequentially starting from the most significant digit. The following context determination method is used during processing of each digit. The context is calculated as a unique combination of binary values of already processed digits, the position of the digit currently being processed and an additional identifier from a limited set of identifiers that describe differences between the predicted color index and the averaged color index being reconstructed during bitwise processing. The correspondence between differences and identifiers is chosen in such a way that smaller (by absolute value) differences are described using a larger number of identifiers and therefore more precision, whereas larger (by absolute value) differences are described with a smaller number of identifiers and therefore less precision.

In addition, special color preprocessing is proposed in order to raise the efficiency of the described method. Colors from the original color space of the image are mapped to an alternate color space containing only the colors that are present in the image. This eliminates modeling of unused color indexes and excludes non-valid combinations of bits from bitwise color index processing process. The size of the alternate color space is smaller than the size of the original color space. Because in many cases a smaller number of digits may be sufficient to represent all indexes of mapped colors, such auxiliary approach can also significantly decrease the complexity of bitwise processing. It should be noted that color mapping itself should not be considered as standalone invention. It comes as an improvement of the color processing method.

Further, in order to increase the performance of the proposed bit modeling and mapping methods, table operations are used for fast calculation of difference identifiers and color mapping.

Further, in order to speed up the processing and decrease memory requirements some of the least significant binary digits can be left unprocessed. Unprocessed digits can be later processed by a simplified algorithm. The number of unprocessed digits is a variable that may be used to match specific performance requirements of an image compression application.

The proposed method is very effective in practice from the point of view of compression efficiency. In many cases this solution significantly surpasses existing methods.

Further, the present invention provides a means to process complex images using limited memory resources. It is also possible to control memory requirements by adjusting the difference identification procedure.

Further, processing of colors on the binary basis significantly simplifies the integration of proposed method into many existing image compression schemes, which in most cases use binary modeling and fast binary encoding methods for generating their code streams.

It must be also emphasized that while many other context-based lossless image compression methods do not provide the simple possibility of merging of general statistical distributions due to implicit color processing (for example, modeling of errors rather than actual colors), the present invention uses explicit binary processing suitable for any kind of statistical merging.

Accordingly, the present invention provides an extremely effective method for context-based color modeling that can be successfully used in many predictive lossless image compression methods.

In its most essential aspect, the present invention is a method for effective color modeling based on color prediction. The method, when applied to image data at any position, employs the following method steps:

The first step (a) comprises color mapping consisting of sub-step (a1) Transforming an original color index to an index in an alternate color space (encoding only); and sub-step (a2) transforming a color prediction index to an index in an alternate color space.

The second step (b) is bitwise processing of the mapped color. For every (or limited number of) digit(s) of the color index binary presentation starting from its most significant digit: (b1) Calculating an averaged index as a floating point mean in the range of possible color indexes with fixed most significant digits in binary presentation that have been processed during previous iterations; (b2) calculating a difference between the predicted and averaged indexes by using the results obtained in steps (a2) and (b1). Then, (b3) determining a difference identifier by using the result obtained in step (b2). In this step it is preferable to use a table describing the correspondence between differences and identifiers.

Next, (b4) a unique context is calculated by combining the values of already processed binary digits, the position of the binary digit currently being processed and the difference identifier obtained in step (b3).

(c) Inverse color mapping (decoding only), comprising: (c1) restoring the original color index using the inverse transformation of the decoded color index from the alternate color space.

This novel method of processing colors is novel and produces results superior to those known in the art.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for designing other methods for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic diagram illustrating a binary color representation and optional mapping procedure;

FIG. 1a is a table for forward color transformation;

FIG. 1b is a table for inverse color transformation;

FIG. 2a is a schematic diagram showing the color processing procedure of the present invention;

FIG. 2b is a table for difference identification for the kth digit as used in the color processing procedure of the present invention; and

FIG. 3 is a block diagram showing the place of the present invention in typical predictive image compression scheme.

### DETAILED DESCRIPTION OF THE INVENTION

Definitions: As used herein, the term “code” means a data representation in the form of a sequence of informational units (bits, bytes, etc.).

The term “economical data representation” as used herein means a data representation using a smaller number of informational units.

The term “compression efficiency” as used herein means the average size of the output code in informational units per input symbol (herein per color pixel).

The term “processing” as used herein means a modeling operation performed during encoding or decoding.

The term “context” as used herein means concomitant data or numerical denotation of concomitant data used to identify a unique state for determination of a conditional probability distribution.

The term “unique combination” as used herein with reference to context formation from data elements means that no two different combinations of data elements are considered as the same context.

The term “color” as used herein means a visually perceptible parameter of an image pixel identified by a unique index.

The term “color mapping” as used herein means a specific transformation of color indices from one index space to another. A “forward transformation” (or simply a “transformation”) stands for conversion of color indexes from the original color space to an alternate color space corresponding to the colors present in image. An “inverse transformation” stands for conversion of color indexes from the alternate color space to the original color space.

The term “averaged index” as used herein means the following. Let's denote the sequence of already processed binary digits of a color index in the alternate color space as bₘbₘ₋₁ . . . bₘ₋ₖ₊₁, where k is the number of already processed binary digits, and m is the number of all binary digits and at the same time the position of the most significant bit. The averaged index is calculated using the following formula

I_{averaged}=(bₘbₘ₋₁ . . . b_{m-k+1 0}0 . . . 0+bₘbₘ₋₁ . . . bₘ₋ₖ₊₁1 . . . 1)/2,

where zeros and ones are assigned to m−k least significant digits.

The term “table operations” as used herein means calculations using precomputed results represented in table form.

The correspondence between difference identifiers and differences between predicted and averaged indexes is not strongly defined in this claim. However, it has been practically proven and comes as an additional claim that in order to achieve the best possible efficiency 1) the number of differences corresponding to a single identifier should grow exponentially with the growth of the absolute difference; 2) although differences should be distinguished by sign (negative vs. positive), difference identification should be symmetrical and sign-independent; 3) all differences less than −2^{m-k-1} should be identified by a single identifier and all differences greater than 2^{m-k-1} should be identified by another single identifier previously defined values of m and k are used).

Difference identification can be efficiently implemented with the use of table operations. It is important to mention that only one table is required for difference identification during processing of each digit; there is no need to use different tables for different combinations of previously decoded binary digits. The number of tables is determined only by the number of digits to be processed.

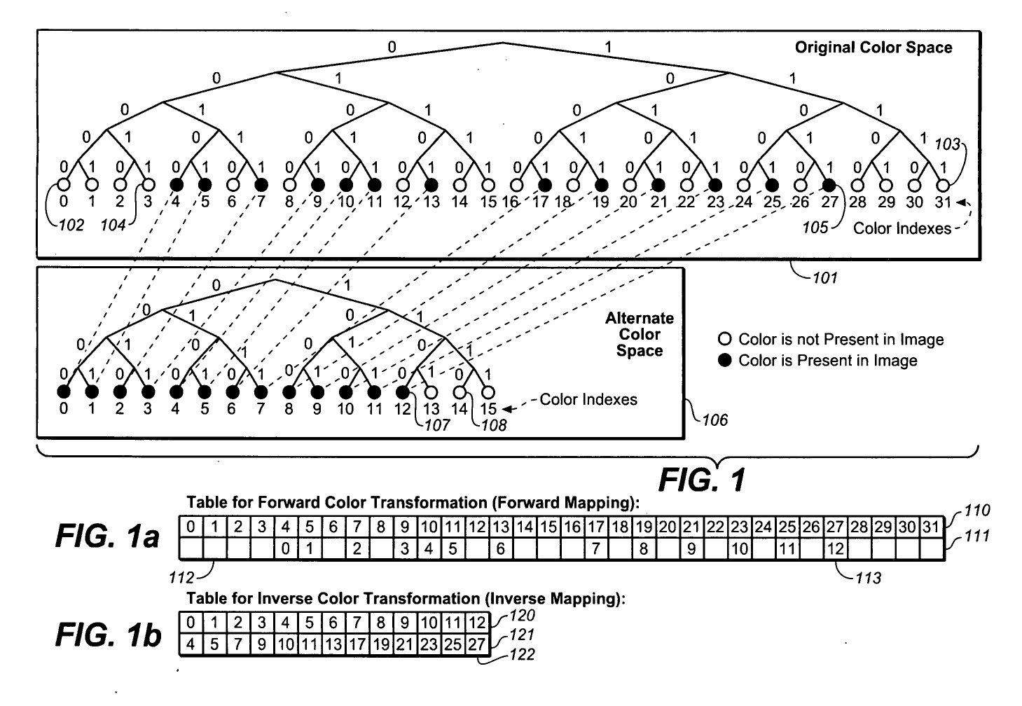

With the foregoing prefatory material in hand, we now refer first to FIG. 1, which shows the binary color representation and optional mapping procedure employed in the present invention. In this view, the previously described first step (a) of the present invention performs a color mapping step comprising two sub-steps, including sub-steps (a1) and (a2).

Sub-step (a1) consists of mapping colors from original color space 101 to alternate color space 106. FIG. 1 shows an example of this mapping. Original color space contains 32 colors. Colors are represented by indexes. In original space 101 color indexes range from 102 to 103. Not all of the colors are present in the image being processed (in this instance only 13 of 32 colors are actually used; unused colors are marked as white circles). For example, color with index 3 in original color space 104 is not present in the image being processed. Consequently, color 104 is not mapped to alternate color space 106. However, color with index 27 in original color space 105 is present in the image being processed. Consequently, color 105 is mapped to color in alternate space 107 which has alternate index 12. It can be seen that binary presentation of original color index is bigger than binary representation of index in alternate color space. However, it should be noted that not all possible binary combinations of color index bits in alternate space 106 correspond to valid colors. In this example color with alternate index 14 108 is not valid, because it does not correspond to any color in original space.

Color mapping can be implemented with the use of table operations. Example of forward mapping table that can be used to simplify the operations in sub-steps (a1) and (a2) is seen in FIG. 1a. First row 110 contains indexes of colors in original space (32 indexes). Second row 111 contains indexes of 13 corresponding colors in alternate space. It can be seen that some of cells of row 111 are empty and others are filled. For example, cell at position 112 in row 111 is empty. This means color with corresponding index 1 in original space 101 is not mapped, because, as it is seen in FIG. 1, it is not actually present in image. Cell at position 113 in row 111 contains value 12. This indicates that color with index 27 in original space 101 is mapped to color with index 12 in alternate space 106.

FIG. 1b contains an example of inverse mapping table, designed to simplify the implementation of sub-step (c1). First row 120 contains indexes of 13 actually used colors in alternate color space. Second raw 121 contains indexes of 13 corresponding colors in original space. It can be seen that all cells of the table are filled with indexes, which means any color from alternate space is uniquely mapped to the corresponding color in original space. As an example, cells at position 122 in rows 120 and 121 contain correspondingly values 12 and 27. This means color with index 12 in alternate color space is mapped during inverse operation to color with index 27 in original color space.

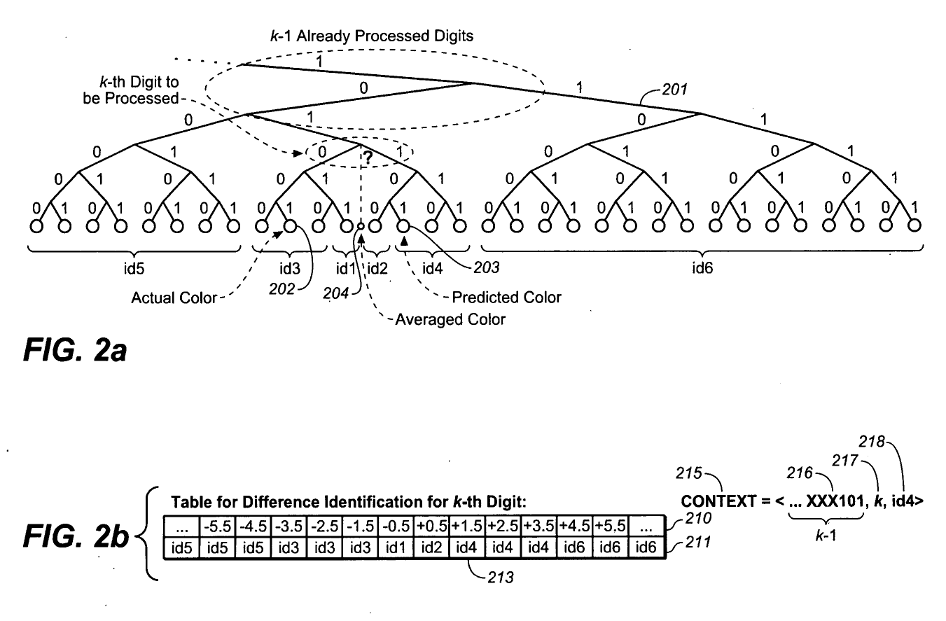

Referring now to FIGS. 2a and 2b, the bitwise mapped color index processing of step (b) is described. In step (b), for every (or limited number of) digit(s) of index binary presentation starting from its most significant binary digit, there are three sub-steps performed:

Sub-step (b1) calculates an averaged index as a floating point mean in the range of possible color indexes with fixed most significant digits in binary presentation that have been processed during previous iterations. An example of this is seen in FIG. 2a, where an averaged index 204 is calculated after k−1 digits of index binary presentation have been processed.

Sub-step (b2) calculates a difference between the predicted and averaged indexes by using the results obtained in steps (a2) and (b1). As seen in the examples of FIGS. 2a and 2b, the value representing the difference between averaged color index 204 and predicted color index 203 is found in the difference identification table shown in FIG. 2b.

Sub-step (b3) determines a difference identifier by using the result obtained in step (b2). In the difference identification table shown in FIG. 2b, each column of row 210 of this table contains the difference values that can be represented (less than −5.5, −5.5 . . . +5.5, more than +5.5). In row 211 of this table, an id value (id1 through id6) corresponds to each value of row 210. In the example shown, the difference between averaged color index 204 and predicted color index 203 is +1.5 (found in column 213 of row 210). Looking up this difference in row 210 of the identification table shown in FIG. 2b, it can be seen that a corresponding identifier id4 is found in column 213 of row 211.

Sub-step (b4) calculates a unique context is by combining the values of already processed digits in color index binary presentation, the position of the digit currently being processed and the difference identifier obtained in step (b3). In FIG. 2b it can be seen that a context 215 is a combination of values of already processed k−1 digits 216, position of the current digit k 217 and identifier id4 218 found in column 213 of row 211 of the identification table shown in FIG. 2b.

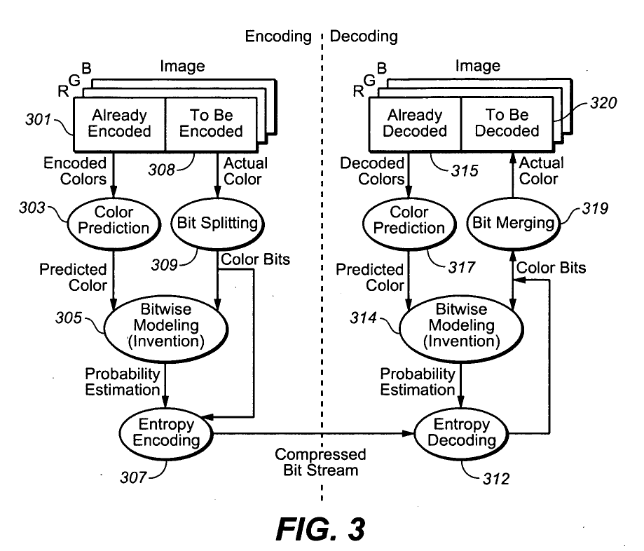

Referring now to FIG. 3, an application of the present invention in the typical predictive image compression scheme is shown. During the encoding process, already encoded color values are fed into color prediction process 303. The predicted color value is then passed into bitwise modeling process 305. Color values that are yet to be encoded are fed into bit-splitting process 309. Color bits from bit-splitting process 309 are passed in parallel to both bitwise modeling process 305 and entropy encoding process 307. In bitwise modeling process 305,wherein steps (a1) through (b4) occur, a probability estimation is produced that is passed to entropy encoding process 307. The output of entropy encoding process 307 is a compressed bit stream that contains the data representing the image being processed.

During the decoding process, entropy decoding process 312 processes the incoming compressed bit stream, passing the resulting color bits in parallel to both bit-merging process 319 and bitwise modeling process 314, wherein step (c) occurs. A value representing already-decoded color values 315 is passed to color prediction process 317. The predicted color value is passed to bitwise modeling process 314. A probability estimation is provided by bitwise modeling process 314 to entropy decoding process 312. In this manner, the data representing the image being processed is encoded into a compressed data steam, and then decoded back into its original values.

Therefore, the above description and illustrations should not be construed as limiting the scope of the invention, which is defined by the appended claims.

The invention claimed is:

1. A method of effective bitwise color modeling for predictive image encoding, comprising the step of estimating each digit of a binary presentation of color index based on a context being computed as a unique combination of binary values of already processed digits of color index, the position of the digit currently being processed and an identifier from a limited set of identifiers to provide an effective difference identification that describes differences between the index of predicted color and the averaged color index being reconstructed during bitwise processing.

2. The method of claim 1, wherein the effective difference identification is regulated by the following rules:
(a) the number of differences corresponding to a single identifier grows exponentially with the growth of the absolute difference;
(b) although differences are distinguished by sign (negative vs. positive), difference identification is symmetrical and sign-independent; and
(c) all differences smaller than −2^{m-k-1} are identified by a single identifier and all differences greater than 2^{m-k-1} are identified by another single identifier, where k is the number of already processed digits of a binary presentation of color index, and m is the number of all digits of this presentation.

3. The method of claim 1, wherein said method is applied to a limited number of the most significant digits of a binary presentation of color index in order to reduce the complexity of color processing.

4. The method of claim 1, further including the step of color mapping from the original color space containing all possible colors to an alternate color space containing only the colors that are present in the image.

5. The method of claim 4, wherein said color mapping step includes using table operations for fast difference identification and color mapping.
